(19) United States
(12) Patent Application Publication
(10) Pub. No.: US 2021/0065082 A1
(43) Pub. Date: Mar. 4, 2021

(54) RESOURCE CONFIGURATION CHANGE PLANNING SYSTEM AND RESOURCE CONFIGURATION CHANGE PLANNING METHOD

(71) Applicant: Hitachi, Ltd., Tokyo (JP)

(72) Inventors: Atsumi TERAYAMA, Tokyo (JP); Shinichi HAYASHI, Tokyo (JP)

(73) Assignee: Hitachi, Ltd.

(21) Appl. No.: 16/808,205

(22) Filed: Mar. 3, 2020

(30) Foreign Application Priority Data
Aug. 27, 2019 (JP) 2019-154316

(51) Int. Cl. G06Q 10/06

(52) U.S. Cl. CPC G06Q 10/06312

(57) ABSTRACT

A system includes a first processing unit that executes a first planning algorithm to evaluate a migration destination resource based on a difference between performance of a migration target resource and reference performance and output a first solution as a migration destination resource state string that indicates a configuration and performance of the migration destination resource that is evaluated as a migration destination, a second processing unit that executes a second planning algorithm to output a second solution according to a mathematical programming method as the migration destination resource state string for the evaluated migration destination resource and uses the first solution to correct the second solution, and a third processing unit that outputs, between the first solution satisfying a time limit and the corrected second solution, a solution in which quality of the resource configuration change plan is estimated and an evaluation value of the plan meets a condition.

### BACKGROUND OF THE INVENTION

### 1. Field of the Invention

The present invention relates to a resource configuration change planning system and a resource configuration change planning method that manage a computer resource configuration.

### 2. Description of the Related Art

An information system plays an important role in supporting modern society and enterprise activities. Particularly, under a background of a requirement for reducing cost and improving reliability in an information system for an enterprise or a public institution, cloud computing or the like in which a resource in the information system is outer sourced on a pay-per-use basis has been widespread instead of holding the resource in the information system.

In a usage state of such a pay-per-use type, a user does not need to prepare or maintain hardware, or an administrator is not needed for maintenance. The user can focus on designing or applying a service and improving quality of a served object using a system rather than a resource of the information system.

In the usage state of the pay-per-use type, the user selects a resource configuration using a method that is appropriate for a system requirement and is regarded to be capable of further reducing a usage fee, and starts to use the resource configuration. A demand for the system changes from moment to moment depending on the user and a surrounding activity situation. Even after the user starts to use the resource configuration of the information system, both processing capability and cost need to be maintained in an optimum state by changing the resource configuration.

However, when the information system is deployed in a large scale, or advantages and disadvantages occur among sections, or a characteristic such as a trend to increase or decrease a demand needs to be considered, it is difficult to estimate an optimum resource configuration due to various factors. Therefore, many techniques have been proposed for dynamically changing the resource configuration and using an appropriate material in an appropriate place.

JP-A-2012-159928 (Patent Literature 1) is an example of a related art that discloses a technique for determining an arrangement to achieve a resource configuration having high usage efficiency by solving an optimization problem based on a predicted value of a resource usage amount in a server virtualization environment in which a virtual machine can be dynamically migrated on a physical server.

An optimization problem of an actual system is that it is difficult to obtain an accurate solution due to nonlinearity or a large state space. A difficulty in this case is that calculation processing for obtaining a solution is large, and a behavior leading to convergence to a solution greatly changes due to object properties even when inputs are similar. Therefore, a solution is not ensured to be obtained within an actual predetermined processing time. Therefore, it is common practice to obtain a practical solution by starting a resource configuration optimization method according to the related art, approximating the optimization problem to a simpler class of problems by linear approximation or the like, or loosely setting an evaluation error and lowering an accuracy. Patent Literature 1 discloses a measure to approximate a state variable by a representative value (a predicted peak usage amount) within a certain period, or to terminate a solution calculation processing at a predetermined time. As a result, a situation in which an accuracy of the solution is actually lowered is inevitable.

On the other hand, since an algorithm that solves the optimization problem including a predicted value particularly has a complex determination criteria and is difficult to be physically interpreted, it is often out of sensuous understanding that a virtual server that has low resource assignment amount and does not significantly contribute to a result is subject to a configuration change, or the like. Since the related art targets on a system capable of flexibly changing a resource configuration such as a server virtualization environment in a short period of time, a sufficient effect can be expected for a temporary method such as performing manual adjustment by an administrator after a change plan is performed or performing re-optimization after a certain period of time even when a proposed configuration change plan cannot be sensuously understood. However, it is difficult to apply the method to a long-term change plan during which the resource configuration change is accumulated or to a target such as a storage sub-system that causes a heavy burden on a configuration change operation. In this case, it is desirable to use a method by which quality of a calculated plan can be determined based on sensuousness or experience of an administrator.

### SUMMARY OF THE INVENTION

An aspect of the present invention is to provide a resource configuration change planning system and a resource configuration change planning method that can efficiently estimate a resource change plan and reduce a burden of creating or comparing plans on a system administrator.

A resource configuration change planning system according to an aspect of the present invention makes a resource configuration change plan for a computer system. The resource configuration change planning system includes a first processing unit that executes a first planning algorithm to evaluate a migration destination resource based on a difference between performance of a migration target resource and reference performance and output a first solution as a migration destination resource state string that indicates a configuration and performance of the migration destination resource that is evaluated as a migration destination, a second processing unit that executes a second planning algorithm to output a second solution according to a mathematical programming method as the migration destination resource state string for the evaluated migration destination resource and uses the first solution to correct the second solution, and a third processing unit that outputs, between the first solution that satisfies a time limit and the corrected second solution, a solution, in which quality of the resource configuration change plan is estimated and an evaluation value of the plan meets a predetermined condition, as a final solution.

According to the aspect of the present invention, the resource change plan can be efficiently estimated and the burden of creating or comparing plans on the system administrator can be reduced.

### BRIEF DESCRIPTION OF THE DRAWINGS

FIG. 1 shows a concept of a method for using a computer system according to an embodiment.

FIG. 2 shows a configuration of the computer system according to the present embodiment.

FIG. 3 shows a configuration of a storage device according to the present embodiment.

FIG. 4 shows an example of grade definition information according to the present embodiment.

FIG. 5 shows a configuration of a management program according to the present embodiment.

FIG. 6 shows an example of volume performance information according to the present embodiment.

FIG. 7 shows an example of pool performance information according to the present embodiment.

FIG. 8 shows an example of storage configuration information according to the present embodiment.

FIG. 9 shows an example of instance configuration information according to the present embodiment.

FIG. 10 shows an internal configuration of a storage configuration change planning program according to the present embodiment.

FIG. 11 shows concepts of states and a state change according to the present embodiment.

FIG. 12 shows a method for using a planning algorithm and a solution thereof according to the present embodiment.

FIG. 13 shows an example of a performance analysis screen according to the present embodiment.

FIG. 14 shows a plan setting input screen according to the present embodiment.

FIG. 15 shows a processing flow according to the present embodiment.

### DESCRIPTION OF THE PREFERRED EMBODIMENTS

Hereinafter, embodiments of the present invention will be described with reference to the drawings. The following description and drawings are examples for describing the invention, and are omitted and simplified as appropriate for clarification of the description. The invention can be implemented in various forms. The number of components may be singular or plural, unless otherwise specified.

In order to facilitate understanding of the invention, a position, size, shape, range, or the like of each component shown in the drawings may not represent an actual position, size, shape, range, or the like. Therefore, the present invention is not necessarily limited to the position, size, shape, range, and the like disclosed in the drawings.

In the following description, although various types of information may be described in terms of expressions such as “table” and “list”, the various types of information may be expressed by other data structures. “XX table”, “XX list”, and the like are referred to as “XX information” to indicate that the “XX table”, the “XX list”, and the like do not depend on a data structure. When identification information is described using expressions such as “identification information”, “identifier”, “name”, “ID”, and “number”, the expressions may be replaced with one another.

When there are a plurality of components having a same or similar function, different subscripts may be attached to the same reference numeral. However, when there is no need to distinguish the plurality of components, the subscripts may be omitted.

In the following description, processing performed by executing a program may be described. The program is executed by a processor (for example, a central processing unit (CPU) or a graphics processing unit (GPU)) to appropriately perform predetermined processing using a storage resource (for example, a memory) and/or an interface device (for example, a communication port), and the like. Therefore, the processor may serve as a subject of the processing. Similarly, the subject of the processing performed by executing the program may be a controller, device, system, computer, or node that includes a processor therein. The subject of the processing performed by executing the program may be a calculation unit, and may include a dedicated circuit (for example, a field-programmable gate array (FPGA) or an application specific integrated circuit (ASIC)) that performs specific processing.

The program may be installed from a program source into a device such as a computer. The program source may be, for example, a program distribution server or a computer readable storage medium. When the program source is a program distribution server, the program distribution server may include a processor and a storage resource that stores a program to be distributed, and a processor of the program distribution server may distribute the program to be distributed to another computer. In the following description, two or more programs may be implemented as one program, or one program may be implemented as two or more programs.

To be described below, the present embodiment provides a system that performs scheduling to correct an index imbalance by re-assigning a candidate volume to another storage pool in a storage system having indexes of performance and usage fee.

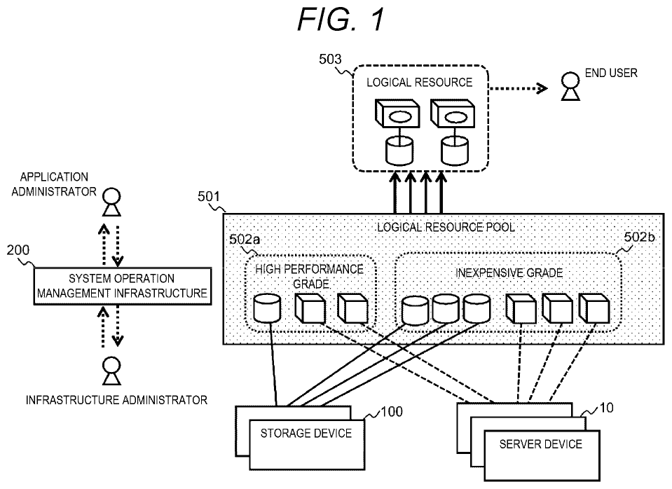

FIG. 1 shows a conceptual configuration of a system that provides a pay-per-use type infrastructure according to the present embodiment.

An application administrator prepares a resource for the purpose of providing an information service to an end user, and performs operation management such as construction. The application administrator mainly determines a required resource type and amount under an allowable charging amount so as to satisfy a system requirement of an application and middle-ware that are required to provide an information service.

An infrastructure administrator maintains an IT infrastructure such that the end user can continuously use an information service with an involvement of the application administrator. The infrastructure administrator mainly performs operation management such as maintenance, construction, and troubleshooting of physical hardware that constitutes the IT infrastructure.

A resource that is physically implemented in a form of one or more storage devices 100 or one or more server devices 10 is once abstracted by a concept of a logical resource pool 501. An entity of the abstraction will be described below, and is functionally based on a server virtualization technique or a storage virtualization technique. The logical resource pool 501 further includes a concept of one or more grades 502 and abstracts a property of the resource. More specifically, for example, a grade 502a that has high performance, a high speed, and a high unit price and an inexpensive grade 502b that does not have a high speed but can be used inexpensively are defined as a group corresponding to performance and prices of resources. Originally, characteristics of physical resources are not uniform due to operation states or configurations at that time. However, the grades 502 are small enough so that an administrator can compare the grades 502 and types of the resources are simplified.

The logical resource pool 501 functions as an abstraction mechanism at a boundary between the application administrator and the infrastructure administrator. The application administrator assigns necessary resources in view of a system requirement from the grades 502 that are determined as appropriate in the logical resource pool 501 and combines the resources with each other to construct a logical resource 503 to operate a desired system. On the other hand, the infrastructure administrator manages a physical hardware configuration so as to provide each grade 502 only without being aware of details of the logical resource 503. A system operation management infrastructure 200 is an entity that implements the logical resource pool 501 and each operation management function, and has a function of operation management such as monitoring, configuration change, and operation state analysis in response to a request from an administrator.

The logical resource pool 501 or an equivalent abstraction thereof has advantages in that an administrator may not acquire specialized knowledge other than the responsibilities described above, resource design for a system requirement can be simplified, the application administrator and the infrastructure administrator can work independently, and the like.

When a large number of systems are operated for end users, there are a plurality of application administrators and a plurality of tenants, and systems managed by the application administrators are shared. The application administrators are responsible for maintaining service quality for the end users by assigning sufficient resources while reducing wasteful charges. In this regard, a design needs to consider how many resources are to be assigned from which grade, and a priority of self-responsible tenants and information systems. The application administrator is a user of the system operation management infrastructure 200. An authority and a range of referring to or changing resource information are determined according to an organization form and a responsible range of an administrator. More specifically, for example, one application administrator is responsible for the logical resource 503. Even when another application administrator uses the same logical resource pool 501 for the logical resource 503, an inappropriate assignment performed by the other application administrator should not be canceled. That is, the system operation management infrastructure 200 manages an attribute such as a role or an authority of a user, and controls information and a function that are to be provided.

When a demand from an end user to an information system changes, or when a relative priority between the information system and an information system surrounding the information system changes, an assignment of the grade 502 of a resource that has been initially assumed may not be appropriate. For example, in a case in which a storage resource is assigned from an expensive grade having high response performance for an application that requires a high IO (input and/or output, data input and/or output) performance, when a demand decreases over time, an IO load reduces while an extra usage fee for a capacity needs to be paid. In such a case, an imbalance between operation performance and a charge can be corrected by re-assigning the resource to another grade.

A target resource is not particularly limited as long as the target resource can be implemented in an IT infrastructure. The target resource may be provided by the server device 10 described above, may be provided by the storage device 100, or may be a network device or a virtual appliance specialized for a function. However, the present embodiment will be described below using an example in which a pay-per-use service that provides a storage area of the storage device 100 as a storage resource.

### Physical Structure and Logical Structure

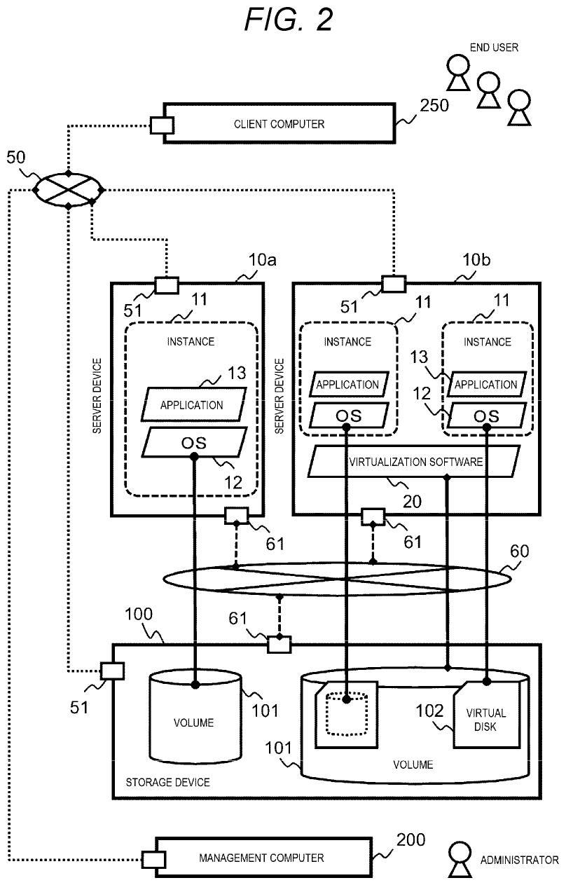

FIG. 2 shows a schema of a target computer system (a resource configuration change planning system 1000) according to the present embodiment.

The computer system includes one or more server devices 10, one or more storage devices 100, the management computer 200, and a network 50 that connects the server device 10, the storage device 100, and the management computer 200 with one another. An application 13 is operated on the server device 10 to provide information service to a user (an end user) of the computer system. Generally, the end user uses a client computer 250 to use the server device 10. The network 50 is not necessarily shared. For example, dedicated networks 60 may be provided to connect the server devices 10 and the storage devices 100. Alternatively, the networks 60 may be provided separately according to the use such as a service network of communication between the application 13 and the user, and a management network of communication between the management computer 200 and the server device 10.

The server device 10 includes a general computer architecture to operate the application 13. Configurations of a plurality of server devices 10 are not necessarily all the same. The server device 10 may be a bare metal server device 10a in which an operating system (OS) 12 is operated directly on the server device 10. Alternatively, the server device 10 may be a virtualization server device 10b in which virtualization software 20 or a container engine is further operated to dynamically divide or multiplex a logical system area 11 that is used by the application 13 or the OS 12. Generally, a cloud service adopts a method for applying a pay-per-use manner to the system area 11, an application 13 environment constructed in the system area 11, and an IT service provided by the application 13. Here, an environment that is a target of a service to be used by users and is equivalent to the system area 11 may be referred to as an instance 11. A processing load generated by the application 13 that is used in the instance 11 and a processing load required for operating the instance 11 may be collectively referred to as a workload. Surely, the workload changes dynamically depending on a usage method of an end user. The grade 502 includes a type and an attribute of a resource assigned to the instance 11. More specifically, the number of cores of a central processing unit (CPU) assigned to the instance 11, an assignment amount of a main storage device (a memory), presence or absence of the virtualization software 20, and the like are designed for each grade 502.

Devices on the network 50 may be directly connected with each other. Alternatively, the network 50 may include one or more network switches and routers to form a plurality of communication paths. Alternatively, the network 50 may be physically or logically divided according to a role or a characteristic of transmitted data. A division method may be a general method in the related art. For example, a dedicated physical device and a dedicated communication protocol such as a storage area network (SAN) 60 may be used, or a technique for logically separating and multiplexing a network space such as a virtual local area network (VLAN) may be used. Since the server device 10 and the storage device 100 communicate with each other via the networks 50 and 60, the server device 10 and the storage device 100 have appropriate network interfaces conforming to the communication protocol.

The storage device 100 is a non-volatile storage device, stores data so as to enable usage of the server device 10, and provides functions such as reading and replicating in response to a request. A storage area for storing data into the server device 10 is generally known as a disk device. The storage device 100 controls the storage area as a logical volume 101. A file system is further defined in the volume 101 that is provided to the server device 10 as a storage area, such that the file system can be easily operated by the OS 12. When the volume 101 is operated by the virtualization software 20, a virtual disk 102 may be provided as a file in the file system in order to further divide the volume 101. Functions of the storage device 100 as a memory device are same in all examples. According to the present embodiment, the storage device 100 controls the volume 101, and how the server device 10 creates the virtual disk 102 based on the volume 101 is controlled by the virtualization software 20.

The management computer 200 centrally manages a configuration and an operation state of the computer system. The management computer 200 is mainly used by an administrator such as an application administrator or an infrastructure administrator who is responsible for operational management of the computer system. The management computer 200 does not need to be shared. In order to improve reliability, a plurality of management computers 200 may be provided to reduce a redundancy or a load. When a processing capability for implementing a target function can be ensured, an application or a program for implementing other services may be operated on the same computer 200.

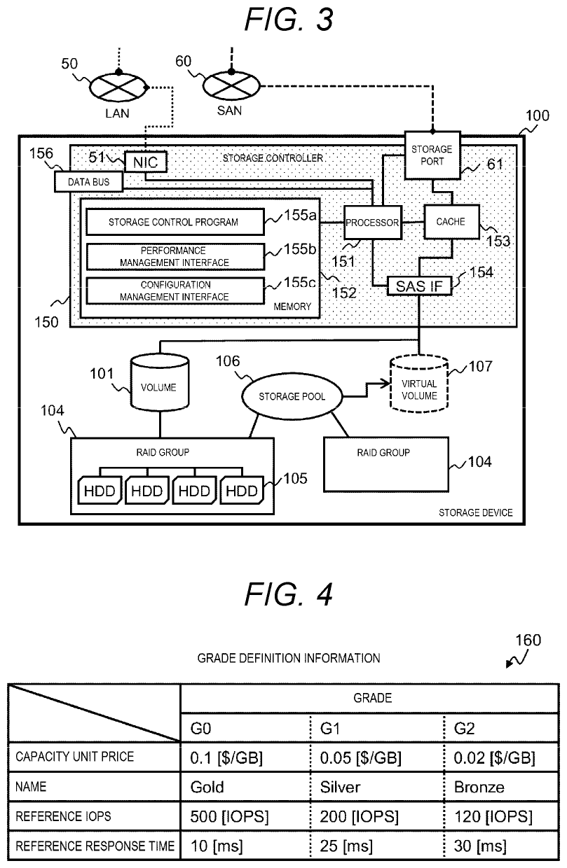

FIG. 3 shows an internal configuration of the storage device 100. The storage device 100 includes a storage controller 150 that centrally manages a configuration of the storage device. A structure of the storage controller 150 is based on a general calculation architecture. The storage controller 150 includes a processor 151, a memory (a main storage device) 152, a communication interface (a storage port 61 and a network interface card 51), a cache 153, a back-end interface (an SAS IF 154) for connection with a drive device, and a data bus 156 that connects the above devices with one another. Since the storage port 61 and the cache 153 directly relate to a processing capability of input and/or output processing performed by the storage device 100, a plurality of storage ports 61 and a plurality of caches 153 are usually provided in accordance with the number of connected server devices 10. If the storage controller 150 has a mechanism to ensure consistency of the storage devices 100, a plurality of storage controllers 150 may be provided depending on requirements such as redundancy, configuration scale, and processing load distribution.

The storage controller 150 further operates a storage control program 155a so as to provide a function of storing and inputting and/or outputting data in response to a request from the server device 10. FIG. 3 shows a configuration in which the storage control program 155a is loaded onto the memory 152 and is operated as a process for illustration. The storage control program 155a provides not only basic functions such as data input and/or output and configuration management of the storage device 100, but also various additional functions such as a copying function of the volume 101 and flow rate management of the storage port 61. Therefore, the storage control program 155a does not need to have an integrated configuration. For example, the storage control program 155a may be modularized for each function and combined as needed, or may operate a process performed by a database, a Web server, or the like as needed for implementation.

Other than the basic function of inputting and/or outputting data and the copying function as described above, the additional functions are simply referred to as storage functions for simplicity. Similar to basic functions of inputting into and/or outputting from the server device 10, the storage functions are operated by consuming a resource in the storage device 100. The storage functions may provide a processing load to the storage device 100 separately from a workload of the application 13 requested by an end user. Examples of the storage functions include various functions such as an in-device copying function for replicating contents of a volume, an inter-device copying function for replication to another storage device case, a cache management function for setting an upper usage limit of the cache 153, and a storage medium layering function for changing a type of a drive device to be assigned according to a usage frequency of a storage area.

The storage controller 150 includes a performance management interface 155b that manages performance information of the storage device 100, and a configuration management interface 155c that manages a configuration. The management interfaces 155b and 155c are used to refer to or change setting of the device 100 from an outside of the storage device 100. The management interfaces 155b and 155c are shown as programs independent of the storage control program 155a in FIG. 3 for illustration. However, as long as the management interfaces 155b and 155c have the same function to achieve the same object, an implementing method of the management interfaces 155b and 155c may have other forms. More specifically, the management interfaces 155b and 155c may have forms such as one module in the storage control program 155a, an external management device, and agent software that can be added after an operation is started. The management interfaces, particularly the configuration management interface 155c, usually control the storage device 100 mainly in response to an instruction from the management computer 200. However, an implementation example in recent implementations is that control is performed directly by the server device 10, the OS 12 of the server device 10, or the virtualization software 20 of the server device 10 instead of the management computer 200.

The storage device 100 includes a plurality of drive devices 105 to store data. Here, the drive device 105 refers to a so-called hard disk drive (HDD) or a solid state drive (SSD). The drive device 105 is generally formed using a configuration method in which reliability and input and/or output performance are improved by a mechanism in which a plurality of devices such as RAIDS cooperate with one another. A configuration of the drive device 105 is not constant. Surely, the drive device 105 can be replaced, increased, and decreased in units of a drive device due to a failure or a shortage of capacity. In order to ensure a storage capacity that can store data in accordance with a data volume used by the computer system, the storage device 100 needs to include a corresponding number of drive devices 105. Several hundred drive devices may be connected to one storage device 100 in accordance with a requirement. The drive device 105 may include not only the HDDs shown in the figure, but also SSDs or flash devices having different capacities, latencies, and transfer bands in accordance with a requirement of a user. The storage device 100 correspondingly includes the back-end interface 154 and the storage control program 155a such that the above devices can be used.

As described above, the storage device 100 logically provides a storage area to the server device 10 in units of the volume 101. Different from the drive device 105 and the like, the logically provided storage area is a logical structure which refers to that no corresponding physically tangible object is directly present. The storage device 100 does not include a storage area of the drive device 105 as a volume. The storage device 100 further includes a logical structure such as a RAID group 104 and a storage pool 106. Configurations of the RAID group 104 and the storage pool 106 are managed by the storage controller 150. More specifically, in the configuration example shown in FIG. 3, one RAID group 104 includes a plurality of drive devices 105, and a storage capacity of the RAID group 104 is managed as the storage pool 106 that includes one or more RAID groups 104.

A volume 107 to be provided to the server device 10 is assigned from the storage pool 106, and is connected with the storage port 61 that communicates with the server device 10 via the SAN 60, whereby the volume 107 is recognized as a storage device by the server device 10. Although the volume may be referred to as the virtual volume 107 to be distinguished from the volume 101 dynamically assigned from the storage pool 106, a role of the virtual volume 107 is the same as a role of the volume 101 in that the virtual volume 107 is a logical storage area of data for the server device 10. Only one storage pool 106 can be defined for the virtual volume 107, and the storage pool 106 which is an assignment source may be referred to as a pool arrangement of the volume 107. In addition, switches constituting the storage port 61 or the SAN 60 may have an access control function such as LUN security (a host storage domain (an HSD)) and zoning for the purpose of controlling whether the volumes 101 and 107 can communicate with a port on the server device 10 side.

A specific area of the cache 153 is assigned to a plurality of volumes 101, and has a function of improving input and/or output performance. An entity of data to be input and/or output by the server device 10 is recorded in the drive device 105 through a logical structure and a physical structure that are hierarchically linked. However, it is extremely difficult for the storage device 100 or the storage controller 150 to know what kind of structure or what kind of meaning data recorded in the volume 101 has. This is because an external function of the storage device 100 such as the OS 12 or the virtualization software 20 on the server device 10 further applies a configuration in which a file system is further defined in the volume 101 or a virtual disk 102 is created.

According to the present embodiment, an entity of the grade 502 in the logical resource pool 501 is determined by the storage pool 106. The storage pools 106 can be constructed to have different performance or capacity unit prices by changing a combination ratio of types of the drive devices 105 and configurations of the RAID groups 104. For example, when the storage pool 106 is mainly configured with HDDs, an inexpensive grade having a low speed and a large capacity can be provided. When the storage pool 106 is mainly configured with SSDs, an expensive grade having a high speed can be provided.

More specifically, the grade 502 is expressed in a form shown in grade definition information 160 in FIG. 4. However, since the grade definition information 160 is used when a volume is purchased by capacity, the listed indexes are values for each volume. Examples of indexes that define the grade 502 for a storage include IOPS (the number of IO per unit time), response time, and capacity unit price. An index such as the IOPS or the response time that changes over time has a reference value for comparison with statistics such as a maximum value, an average value, and a percentile in a predetermined period.

More specifically, since the IOPS appears in proportion to a magnitude of a processing load, for example, an average IOPS of a volume is expected to fall within a range (a recommended range) from 20% to 90% of a reference IOPS in a normal state. In case of the response time, since the shorter the response time, the higher a speed, an operation is expected to be performed in a manner of not exceeding a reference response time in a normal state. When comparing a performance value of a volume with the recommended range or a threshold value using such a reference value, a state in which the volume has an expected normal value is referred to as appropriate and a state in which the volume does not have a normal value is referred to as inappropriate. The grade 502 is a service specification presented to an application administrator or an infrastructure administrator when the computer system is provided as a resource.

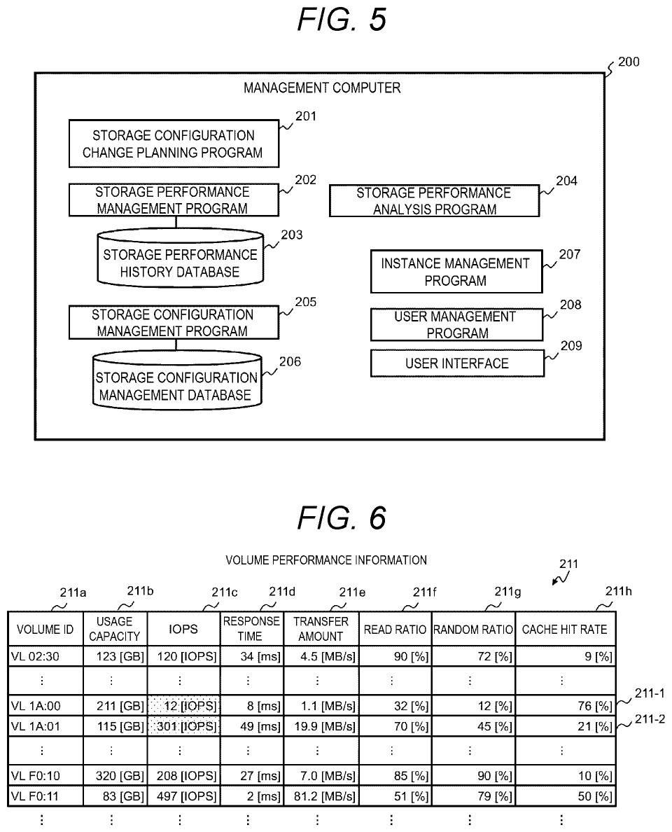

FIG. 5 shows a program configuration of the management computer 200. According to the present embodiment, the management computer 200 includes a storage configuration change planning program 201 that creates a configuration change plan for the storage device 100, a storage performance management program 202 that manages performance information, a storage performance analysis program 204 that statistically analyzes performance information, a storage configuration management program 205 that manages a configuration of the storage device 100, an instance management program 207 that manages an instance configuration, a user management program 208 that manages user information, a storage performance history database 203 and a storage configuration management database 206 that efficiently store and process information managed by a management program as needed. The storage configuration management program 205 refers to and changes physical and logical structures of the storage device 100 in cooperation with the storage controller 150 in the storage device 100, and manages setting. Similarly, the storage performance management program 202 monitors, in cooperation with the storage device 100, an operation state of the storage device 100 by referring to and storing operation performance of each resource held by the storage device 100. The management computer 200 may further include a user interface 209 that has a function of receiving an input from a user or displaying a processing result.

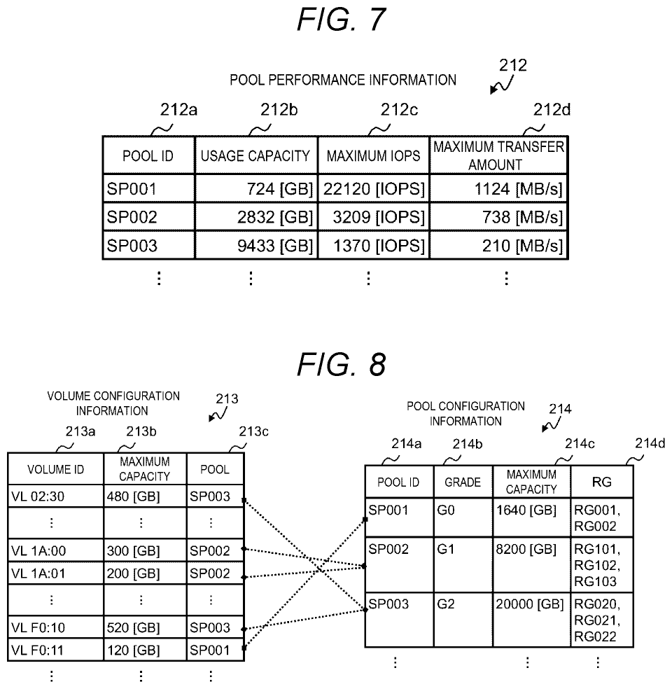

The storage performance management program 202 manages performance information of the storage device 100 such as volume performance information 211 shown in FIG. 6 and pool performance information 212 shown in FIG. 7. Past performance information is stored as time series data in the storage performance history database 203, and is processed into a format such as an average value or a maximum value according to usage. The volume performance information 211 is a performance value indicating an operation state such as, for a volume ID 211a, an actual usage capacity 211b, an IOPS 211c, a response time 211d, a transfer amount 211e, a read ratio 211f indicating a read command ratio of an IO, a random ratio 211g indicating a random access ratio of an access pattern, and a cache hit rate 211h indicating an assignment ratio of data stored in the cache 153 at a time of reading the IO. The pool performance information 212 is expressed in forms such as, for a pool ID 212a, a usage capacity 212b, a maximum IOPS 212c processable by the storage pool, and a maximum transfer amount 212d. The volume 101 is assigned from the storage pool 106. A total amount of performance values of the volume 101 assigned from the same storage pool 106 does not exceed maximum performance of the storage pool 106.

The storage performance analysis program 204 acquires performance information using the storage performance management program 202, statistically processes the performance information, and provides an analysis function for performance of the storage device 100 to a user. More specifically, examples of the analysis function include calculation of an increase and/or decrease tendency, prediction of performance at a future time point, and detection of an abnormal value.

The storage configuration management program 205 manages configuration information of the storage device 100 such as volume configuration information 213 and pool configuration information 214 shown in FIG. 8. The volume configuration information 213 is expressed by a maximum capacity 213b and a storage pool 213c of an assignment source for a volume ID 213a. The pool configuration information 214 is expressed by an associated grade 214b, a maximum capacity 214c, and a RAID group 214d that constitutes the storage pool for a pool ID 214a. The volume configuration information 213 and the pool configuration information 214 can be defined in accordance with physical and logical structures and a relationship can be found by matching corresponding items.

For example, the pool ID 214a in the pool configuration information 214 is specified from the item pool 213c in the volume configuration information 213, and it can be determined which grade 214b the volume ID 213a corresponds to. In the storage configuration management program 205, configuration information is stored in the storage configuration management database 206, and the configuration information is retrieved, referred to, and changed as needed. The storage controller 150 changes a logical configuration of the storage device 100.

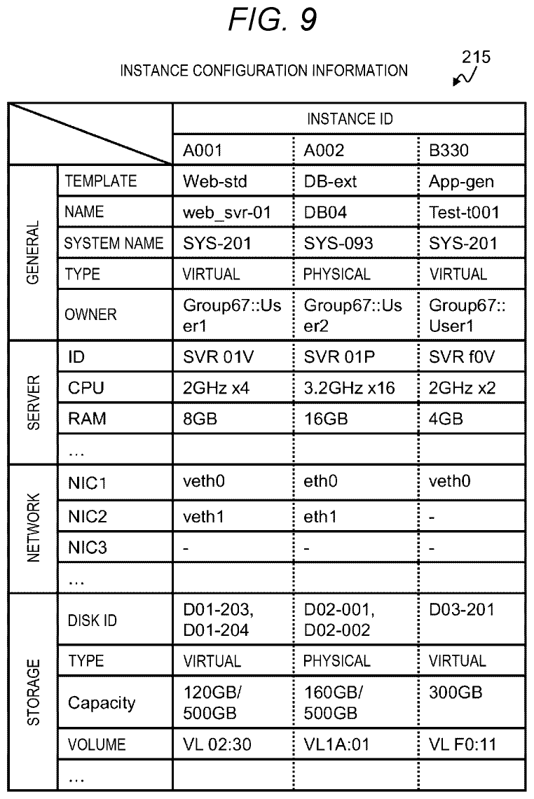

The instance management program 207 manages instance configuration information 215 as shown in FIG. 9 for the instance 11 operated in the server device 10. The instance configuration information 215 includes various resources that constitute the instance 11, and information about a usage method such as an owner or a system name. When the application administrator operates a configuration of the instance, the application administrator refers to a resource that is associated with a responsible system, section, tenant, or the like.

The user management program 208 manages an administrator account, and controls and authenticates an access authority to a management program. As a result, an available analysis function or configuration management function, and browsing of performance data are restricted according to an attribute of a user. A user such as the application administrator or the infrastructure administrator of the management computer 200 has information of a static attribute such as an access authority, and information of a dynamic behavior such as an operation performed and a resource referred to by the user in the past. Similarly, the user is managed by the user management program 208.

When the application administrator attempts to construct a new system, the application administrator defines the instance configuration information 215 and creates a required number of instances 11. Particularly, the desired grade 502 is selected to instruct the storage configuration management program 205 to meet a system requirement when a storage resource is required. Among the storage pools 106 that are associated with the grade 502, the storage configuration management program 205 detects a storage pool that is sufficient to have a free space and a performance margin above a predetermined threshold, and ensures a present volume or a newly created volume as the storage resource. The storage configuration management program 205 updates configuration information in the storage configuration management database 206 in response to a configuration change such as creation of a new volume, and changes a logical configuration of the storage device 100 via the storage control program 155a in the storage controller 150. The user management program 208 manages a history of the performed configuration change as one behavior of a user who issues an instruction.

On the other hand, the infrastructure administrator predicts and detects performance and capacity shortage by the storage performance analysis program 204, and takes a necessary measure such as adding the RAID group 104 or changing a volume assignment. When the infrastructure administrator uses the storage performance analysis program 204, an account and an operation history are also managed in the user management program 208. Accordingly, a behavior such as a time or the number of times that is taken when the administrator performs analysis work on any resource can be known and a resource range of high user interest can be determined.

### Configuration and Function of Planning Program

As described above, when the application administrator attempts to construct a system, a storage resource with an appropriate specification can be ensured by selecting the grade 502. However, along with an operation of the system continues, a change in demand and a change in relative importance with respect to other systems may cause a situation in which an initial grade selection is not appropriate. For example, when an application having a strict DO requirement is operated, an expensive grade having a high speed is initially selected and constructed. However, when a demand for an information service provided by the system decreases over time, the grade having a high speed is not needed. Therefore, if the expensive grade continues to be used thereafter, an unnecessary fee is paid.

Accordingly, when a difference between performance provided by the grade and a processing demand for a resource occurs, the grade needs to be re-selected appropriately. An entity of the grade 502 is the storage pool 106. A grade change can be implemented by changing a pool arrangement of the volume 107 that is used by the system, that is, migrating the volume to the storage pool 106 having an appropriate grade. To migrate the volume 107 between the storage pools 106, the storage device 100 creates the new volume 107 in a storage pool of a migration destination storage and then copies data of the volume 107 of a migration source. At a time point of completion, an IO request is switched to the volume 107 of the migration destination. Alternatively, when the virtualization software 20 has a migration function of the virtual disk 102, similar copying and IO switching may be performed on the virtualization software 20 side.

In any migration method, a migration of a storage area requires a copying amount corresponding to a usage capacity, and may cause unignorable influences, for example, may cause pressure on other IO processing, or an IO band may be temporarily reduced at a time of switching. Since processing cannot be performed when a structural capacity limit of the drive device 105, the storage pool 106, or the like is exceeded, the migration needs to be performed such that a sum of the migration and other general workloads does not exceed maximum performance and maximum capacity throughout a migration period. In a large scale environment in which a large number of instances are operated, the migration operation should be efficiently performed since a large amount of volumes whose grades are to be examined are generated. In view of this circumstance, not only a source amount, but also a change plan to migrate which one of the volumes 107 to which one of the storage pools 106 in what kind of order needs to be carefully studied. In addition, it is important to be able to quickly estimate a change plan corresponding to a large scale environment.

Since a resource is managed by selecting a grade by an administrator of the computer system, it is desirable that the administrator can also understand and study a policy of the change plan. For example, when a resource having a low load is assigned from an expensive grade until a later stage of a change plan, even if a final fee and performance are optimized, an intuitive priority of the administrator is different. Alternatively, since the administrator can know which resource is a responsible resource, the administrator surely cannot accept when an optimization effect of the resource is low throughout the change plan.

In view of the above circumstance, an object of the present system is to create a change plan to migrate a volume between storage pools so as to have an appropriate grade corresponding to required processing performance while taking restrictions of performance and capacity into consideration. A plan that reflects an index such as a fee or performance is created so as to obtain understanding of the administrator. Therefore, an important migration target is estimated based on an attribute or a behavior of a user, and a simple planning algorithm that can be understood by the administrator and a strict planning algorithm that mechanically optimizes cost and performance of a resource are used efficiently and appropriately.

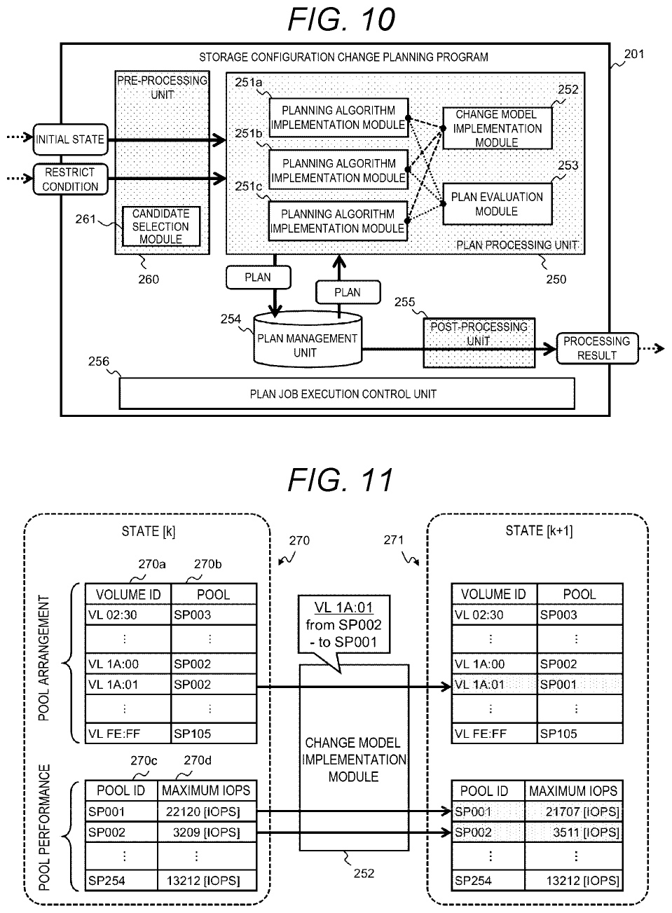

FIG. 10 shows an internal structure of the storage configuration change planning program 201 according to the present embodiment. The storage configuration change planning program 201 includes a plan processing unit 250 that executes a plurality of simple planning algorithms or strict planning algorithms, a pre-processing unit 260 that selects a configuration change target, a plan management unit 254 that stores a plan, a post-processing unit 255 that generates a result, and a planning job execution control unit 256 that operates the above units in cooperation with one another. The pre-processing unit 260 includes a candidate selection module 261 that determines an application range of a planning algorithm in cooperation with another management program. The plan processing unit 250 includes a planning algorithm implementation module 251 that implements a planning algorithm. A change model implementation module 252 that represents a change in a performance value or a logical configuration due to a configuration change, and a plan evaluation module 253 that evaluates quality of plans are commonly used in the plan processing unit 250.

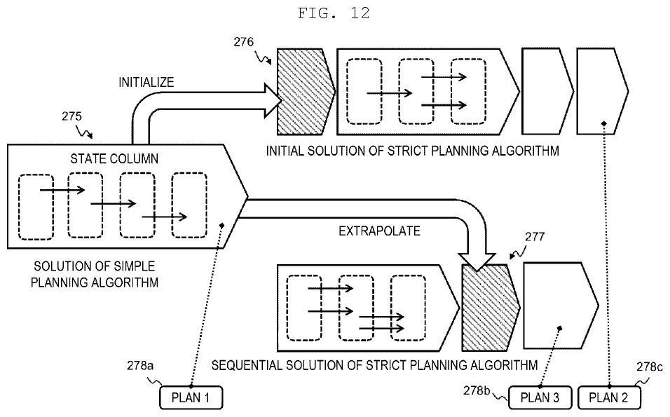

A state according to the present embodiment is expressed by a logical configuration and performance value of the storage device 100 including a pool arrangement of volumes, that is, the storage pool 106 which is an assignment source of the volume 107 when a certain volume 107 is assigned from a certain storage pool 106. FIG. 11 shows an example of the state. For example, a pool arrangement shown in FIG. 11 holds information indicating that a volume ID 270a is assigned from which pool 270b and a performance value is held as a maximum IOPS 270d for a pool ID 270c. Information managed as the state corresponds to the storage configuration information (shown in FIG. 8) and the storage performance information (shown in FIGS. 6 and 7) in the management program.

The state is calculated by the plan processing unit 250 in a simulated manner and is written as a state k or the like which is referred to as a state 270 at discrete time points tₖ. Strings of the state k that is a final state or a middle state according to a change plan are referred to as solutions of an algorithm. Some states that cannot be executed or cannot be reached occur during calculation. More specifically, a state in which a sum of performance required by a volume exceeds maximum performance of a pool cannot be physically executed, or a state via an instantaneous exchange (a margin required by a migration cannot be ensured) cannot be reached. These states may be calculated by an algorithm. However, these states are dismissed in a middle or a final stage of the algorithm, and are not adopted as change plans.

For example, a simple planning algorithm implemented in the planning algorithm implementation module 251 is as follows. Based on performance and a charging amount of the target volume 107, the algorithm sequentially migrates from a volume having a larger difference from a reference performance defined in a current grade or a volume having a large charging amount into a storage pool having large free performance. Accordingly, a volume to be migrated may be determined based on the difference from the reference performance and a migration destination of the volume may be evaluated sequentially, so that a solution can be obtained at a high speed. That is, when n volumes to be migrated are determined, a string of the state k (k=0, 1 . . . n) up to when an nth migration is completed is a solution of the simple planning algorithm, and a calculation is completed by always evaluating n migrations. Since the administrator can easily retrieve the volume having a large difference from the reference performance using the storage performance analysis program 204, and the algorithm is used to select a migration destination so as to cancel the volume completely, an intuitive understanding of the administrator can be easily obtained.

On the other hand, an optimum solution can be mechanically obtained by using a general mathematical programming method such as a genetic algorithm, a branch and bound method, and reinforcement learning. As an example of an evaluation function, the optimum solution in this case minimizes an objective function. For example, a change plan is obtained to finally reach a state in which a resource usage rate or a total charging fee is minimized. The strict planning algorithm implemented in the planning algorithm implementation module 251 uses these mathematical programming methods. However, these mathematical programming methods are algorithms that iteratively improve a sequential solution, and a convergence is not uniform depending on a selection of the sequential solution or an improvement measure. A calculation time required for a convergence of the strict planning algorithm to a certain solution is undefined. The strict planning algorithm may not converge within an allowable time depending on the nature of a problem, such as a large number of dimensions of a state.

Therefore, in the present embodiment, the candidate selection module 261 restricts a candidate that applies the strict planning algorithm, and a solution obtained by the simple planning algorithm is used in the sequential solution. Accordingly, the convergence can be accelerated, and at the same time, a characteristic of a solution calculated with emphasis on an index that can be understood by the administrator can be reflected in the strict planning algorithm.

A method for using solutions of the simple planning algorithm and the strict planning algorithm is conceptually shown in FIG. 12 for illustration. As described above, a solution 275 of the simple planning algorithm is expressed as a string of a state indicating a change when a migration is repeatedly performed. In one example of the strict planning algorithm, the solution 275 of the simple planning algorithm is set as an initial solution 276, and a subsequent sequential solution, for example, is derived by partially changing a volume to be migrated or a migration destination pool at a certain time point.

If a volume determined to be of high user interest is changed, a better solution than the solution 275 of the simple planning algorithm may be obtained earlier. In another example of the strict planning algorithm, the solution 275 of the simple planning algorithm is used from the middle of the iteration to correct a sequential solution 277. For example, if a previous sequential solution in a part of the volume that is determined to be of high user interest is replaced in the solution 275 of the simple planning algorithm by a migration, a solution of the strict planning algorithm may quickly converge near the solution 275 of the simple planning algorithm. Accordingly, the simple planning algorithm and the strict planning algorithm are actually implemented frequently in the planning algorithm implementation module 251, and a solution that is likely to be implemented is obtained as a candidate for a change plan to be presented to a user. Solutions of the algorithms may be managed as a plan 278 by the plan management unit 254, reflected in a final processing result, or diverted to another planning algorithm.

The change model implementation module 252 estimates a change in a state of a resource change. For example, FIG. 11 conceptually shows a change from the state 270 to the subsequent state 271. When a pool arrangement of a certain volume is changed, the storage pool 270b corresponding to the volume is updated from a migration source pool to a migration destination pool. A performance value after a migration is calculated using a performance value before the migration. More specifically, for example, a post-migration IOPS of the migration destination pool is obtained by adding an IOPS of a volume to be migrated to a pre-migration IOPS of the migration destination pool. Similar to a usage capacity, a performance value is obtained by addition and subtraction only. Not only the performance value, but also a response time, the pool maximum IOPS 270d, and the like change nonlinearly due to an IO characteristic, a port configuration, or the like.

In order not to deviate from the present embodiment, a given formulation is assumed in a change model. In any case, the change model implementation module 252 provides the changed state 271 using the state 270 before the change in any configuration change (migration), and the states are common regardless of a type of a planning algorithm.

The plan evaluation module 253 estimates quality of the change plan using an objective function. Here, the quality of the change plan refers that the number of volumes whose performance is within an appropriate range defined by the reference performance is large, or a sum of charging amount is small in a target system. More specifically, the objective function is obtained by expressing, for example, an index of a charging amount or performance by a weighted linear combination, and an importance degree of the index can be set by adjusting a weight.

The planning job execution control unit 256 controls timing when the planning algorithms and a change plan target are applied, and stops planning processing at a time point when a predetermined time limit is elapsed. After the planning processing is stopped, the post-processing unit 255 ranks plans based on evaluation values generated by the plan evaluation module 253, and generates a processing result. The planning algorithm implementation module 251 can be executed in parallel without limitation. Alternatively, the planning job execution control unit 256 may further include a mechanism that stores a processing history to preferentially apply an algorithm that can obtain a good past plan evaluation and continuously improve a change planning function.

### Processing Flow of Planning Program

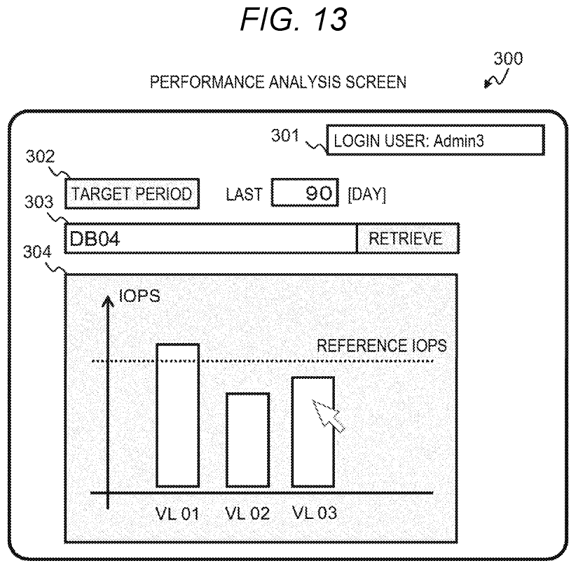

When the storage configuration change planning program 201 is used, it is regarded that the application administrator uses the management computer 200 to monitor and analyze storage performance. An analysis in such a case is shown, for example, on a performance analysis screen 300 in FIG. 13. An analysis target period 302 is specified and a responsible system is retrieved according to a condition 303 such as a name. Whether the analysis is appropriate, that is, whether a value is good compared with the reference performance is determined according to a diagram 304. It is assumed that, for a system or an application that a user is responsible for, the user performs an analysis on a daily basis, and for a system or an application that the user is not responsible for, an access is restricted or a frequency of analysis is low. A user 301 is specified by login processing provided by the user management program 208, and what kind of attribute the user who uses a system or an application has and how the user behaved up to that point can be determined.

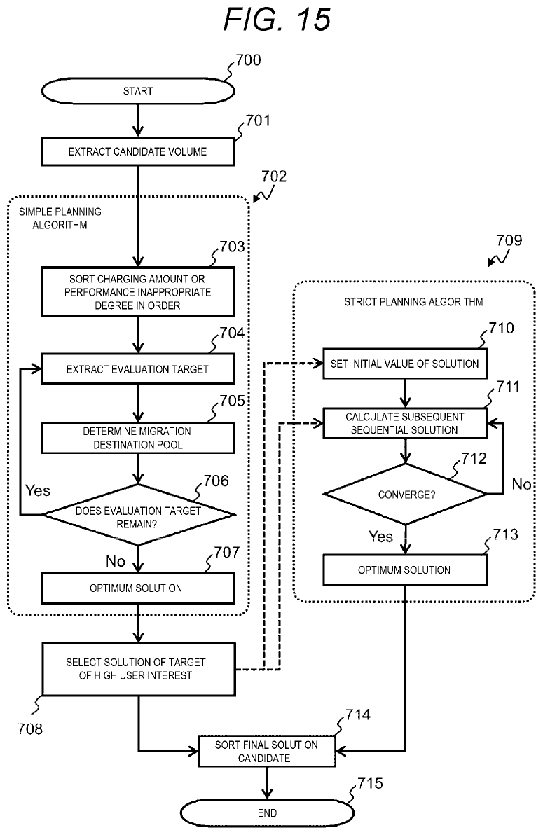

FIG. 15 shows a processing flow executed by the storage configuration change planning program 201 according to the present embodiment. Steps described below are mainly controlled by the planning job execution control unit 256. As described above, a system or a volume of high user interest can be specified using the performance analysis screen 300 or the like in FIG. 13 on a daily basis before start 700. A level of interest is determined according to a quantitative value of a behavior such as the number of times the user retrieves and browses, and a duration or a frequency of a period when the user retrieves and browses. There is a limit (a time limit) for a time when a change plan processing can be used. The processing needs to be completed within a predetermined period of time or in accordance with a request from the user.

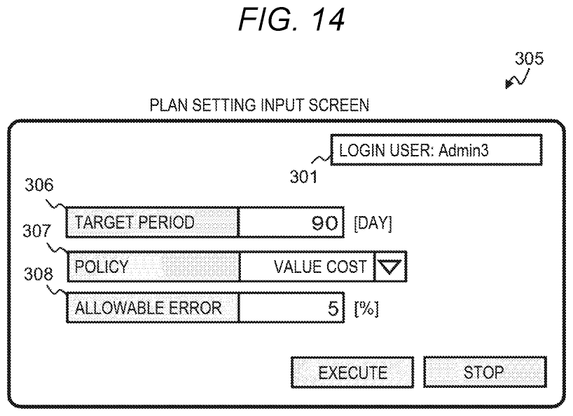

At the start 700, an input from the user is received through an interface such as a plan setting input screen 305 shown in FIG. 14. As shown in FIG. 14, after the user 301 is identified by the user management program 208, a change plan is set in terms of items that is simple and easy for an administrator to understand, such as a target period 306 of the change plan, a policy 307 of the plan, and an allowable error 308 that is used in convergence determination of a strict planning algorithm or the like. For example, the user management program 208 sets a condition (the target period 306, the policy 307, and the allowable error 308) in accordance with a user attribute (a login user “Admin 3” in FIG. 14) that is input via the user interface 209, and restricts a target for applying the strict planning algorithm so as to meet the set condition.

The candidate selection module 261 extracts a candidate volume to be migrated in step 701. An extraction criteria is mainly based on whether the volume is appropriate by referring to a grade definition and the level of user interest described above. Whether the volume is appropriate or inappropriate is determined using the volume performance information 211 and comparing with the grade definition information 160. Since the volume performance information 211 does not directly indicate that the volume is assigned from which grade, the candidate selection module 261 identifies the grade 214b by matching the volume configuration information 213 and the pool configuration information 214 as needed. In this case, in order to correct an imbalance between performance and charging, for example, the candidate selection module 261 determines that a volume (for example, 211-2 in FIG. 6) whose IOPS is larger than a reference should be migrated to a storage pool of a grade having higher performance. In contrast, the candidate selection module 261 determines that a volume (for example, 211-1 in FIG. 6) whose IOPS is smaller than the reference should be migrated to a storage pool of an inexpensive grade. For example, the candidate selection module 261 of the pre-processing unit 260 selects a migration target resource in order from a resource whose performance index is low (for example, a free space of a volume is less than a predetermined threshold) or a resource whose usage fee is higher than a reference value.

After the candidate volume is extracted, the planning algorithm implementation module 251 first applies a simple planning algorithm 702. A method for applying the algorithm 702 is the same regardless of whether the volume is a volume of high user interest.

In the simple planning algorithm 702, the planning algorithm implementation module 251 first sorts a charging amount or an inappropriate degree in descending order in step 703. Here, the inappropriate degree refers to a difference between a performance value of the volume and a reference performance value. The larger the value is, the earlier a migration is evaluated. The policy 307 input by the user is taken into consideration as to whether a priority is given to the charging amount or the inappropriate degree.

In step 704, the planning algorithm implementation module 251 sequentially extracts unevaluated volumes from candidates sorted in the previous step 703, and sets the unevaluated volumes as evaluation targets to examine a migration destination pool.

In step 705, the planning algorithm implementation module 251 uses the change model implementation module 252 to determine the migration destination pool. As described above, since a candidate (a grade having high performance or an inexpensive grade) of a grade to be migrated is known by comparing the candidate with the reference performance, the planning algorithm implementation module 251 retrieves a storage pool belonging to the grade from the pool configuration information 214, and evaluates whether the storage pool is appropriate as a migration destination in descending order of free space performance. In this case, the planning algorithm implementation module 251 sets the migration destination pool at a time point when a sufficient free space and performance are found to be equal to or larger than a predetermined threshold. That is, the planning algorithm implementation module 251 selects a migration destination resource in descending order of performance indexes (for example, in order in which the free space is larger than a threshold), and determines to migrate the migration target resource selected by the candidate selection module 261 to the migration destination resource. When the free space and the performance cannot be ensured even if all storage pools are checked, the planning algorithm implementation module 251 determines that the volume has been evaluated but not migrated.

In step 706, the planning algorithm implementation module 251 determines whether an unevaluated volume remains. The processing returns to step 704 when the planning algorithm implementation module 251 determines that an unevaluated volume remains (step 706: Yes). The processing proceeds to step 707 when the planning algorithm implementation module 251 determines that evaluation for all volume has been completed (step 706: No), and a result is set as an optimum solution (the solution 275 of the simple planning algorithm in FIG. 12).

In step 708, the planning algorithm implementation module 251 selects a solution for a volume that is of high user interest and has been extracted in advance, and proceeds to apply a strict planning algorithm 709. The planning algorithm implementation module 251 may apply the strict planning algorithm 709 to all solutions of the simple planning algorithm only when a processing time is sufficiently short to be equal to or less than a predetermined threshold relative to the time limit.

The strict planning algorithm 709 is generally an iterative solution. The planning algorithm implementation module 251 uses the solution of the simple planning algorithm 702 selected in step 708 as an initial value (the initial solution 276 in FIG. 12) of the iterative solution (step 710), or as a sequential solution (the sequential solution 277 in FIG. 12) or a part of the sequential solution (step 711). Accordingly, an effect can be expected that an iteration of the strict planning algorithm 709 is likely to converge and a good solution is found near the solution of the simple planning algorithm 702 using the solution of the simple planning algorithm 702. Although the convergence of solutions in the strict programming algorithm 709 is indefinite depending on the nature of a problem or a required accuracy and there is no guarantee for always obtaining a good solution, the simple planning algorithm 709 guarantees at least a minimum solution.

In step 712, the planning algorithm implementation module 251 determines whether the iteration of the strict planning algorithm 709 in step 711 is converged. When the planning algorithm implementation module 251 determines that the iteration is converged (step 712: Yes), the processing proceeds to a next step 713, and an obtained sequential solution is set as an optimum solution (the sequential solution 277 of the strict planning algorithm in FIG. 12). On the other hand, when the planning algorithm implementation module 251 determines that the iteration is not converged (step 712: No), the processing returns to step 711 to calculate a sequential solution.

In step 714, the planning job execution control unit 256 terminates the processing in the plan processing unit 250 due to a time limit. Thereafter, the post-processing unit 255 obtains a final solution candidate from the solution of the simple planning algorithm 702 and the sequential solution of the strict planning algorithm 709 that are stored in the plan management unit 254. That is, at a time point when the time limit is reached, a solution that gives a good evaluation value to a predetermined evaluation function between the solution of the simple planning algorithm 702 and the sequential solution of the strict planning algorithm 709 is regarded as a final solution. The plan management unit 254 stores the plans 278a, 278b, and 278c that are obtained using solutions obtained by the planning algorithm implementation module 251 in a memory (a main storage device) of the management computer 200.

Some users value an effect of executing a change plan rather than a detail of which volume being migrated in what order. Therefore, as a result of the storage configuration change planning program, a final value and a transition of the performance and the charging amount that are given by the plan evaluation module 253 may be output together and the user may be provided with a determination material to compare a plurality of solution candidates.

According to the present embodiment, a resource configuration change planning system that makes a resource configuration change plan for a computer system includes a first processing unit (the planning algorithm implementation module 251), a second processing unit (the planning algorithm implementation module 251), a third processing unit (the planning job execution control unit 256). The first processing unit executes a first planning algorithm (the simple planning algorithm 702) to evaluate a migration destination resource based on a difference between performance of a migration target resource and reference performance and output a first solution (the solution of the simple planning algorithm 702) as a migration destination resource state string that indicates a configuration and performance of the migration destination resource that is evaluated as a migration destination. The second processing unit executes a second planning algorithm (the strict planning algorithm 709) to output a second solution (the solution of the strict planning algorithm 709) according to a mathematical programming method as the migration destination resource state string for the evaluated migration destination resource. The second processing unit uses the first solution to correct the second solution. The third processing unit outputs, between the first solution that satisfies a time limit and the corrected second solution, a solution (for example, a solution having a best evaluation value), in which quality of the resource configuration change plan is estimated and an evaluation value of the plan meets a predetermined condition, as a final solution. The resource configuration change planning system can efficiently execute a resource configuration change plan within a predetermined time by combining the simple planning algorithm that is simplified using an intuitive and strong restriction and the strict planning algorithm that mechanically solves a minimization problem.

In particular, a solution (a change plan) can be obtained at an early stage by a simple planning algorithm that intuitively reflects a service level index such as a difference between cost and standard performance in a contract, the solution of the strict planning algorithm can be improved using the solution as an initial value or an extrapolation value, and a convergence of an iteration can be improved. An accuracy or a calculation amount of a solution can be adaptively adjusted by evaluating an interest level according to an explicit request or an implicit behavior of a user and determining an application range of algorithms.

That is, according to the present embodiment, a resource configuration change plan is calculated with high accuracy and within a predetermined processing time while reflecting a user specified item and a determination criteria, so that even for a long-term resource configuration change or a storage system configuration change that requires careful rearrangement, the change plan can be efficiently estimated, and a burden of creating or comparing plans on a system administrator can be reduced. The first solution of the first planning algorithm that can obtain a solution easily and intuitively is used to improve the second solution of the second planning algorithm that can obtain a more accurate solution, so that a solution having high accuracy is obtained at a high speed. A range of a target to which the second planning algorithm is applied is adjusted according to an attribute or a behavior of the user, and many pieces of processing are applied to a resource group that is presumed of high interest, so that an accurate change plan can be derived.

As described above, according to the present embodiment, both a processing time limit and an accurate solution can be satisfied by appropriately using a planning algorithm that can obtain a solution easily and intuitively and a planning algorithm that can obtain a solution mechanically and strictly based on an attribute or a behavior of a user.

What is claimed is:

1. A resource configuration change planning system that makes a resource configuration change plan for a computer system, the resource configuration change planning system comprising:
a first processing unit that executes a first planning algorithm to evaluate a migration destination resource based on a difference between performance of a migration target resource and reference performance and output a first solution as a migration destination resource state string that indicates a configuration and performance of the migration destination resource that is evaluated as a migration destination;
a second processing unit that executes a second planning algorithm to output a second solution according to a mathematical programming method as the migration destination resource state string for the evaluated migration destination resource, and uses the first solution to correct the second solution; and
a third processing unit that outputs, between the first solution that satisfies a time limit and the corrected second solution, a solution, in which quality of the resource configuration change plan is estimated and an evaluation value of the plan meets a predetermined condition, as a final solution.

2. The resource configuration change planning system according to claim 1, further comprising:
a pre-processing unit that selects the migration target resource in order from a resource having a low performance index or a high usage fee, wherein
the first processing unit selects the migration destination resource having a high performance index and migrates the migration target resource selected by the pre-processing unit to the migration destination resource.

3. The resource configuration change planning system according to claim 1, further comprising:
a user management unit that sets a target to which the second planning algorithm is applied in accordance with an attribute of a user that is input via an input unit, wherein
the first processing unit, the second processing unit, and the third processing unit perform processing on a resource that is the target.

4. The resource configuration change planning system according to claim 1, wherein
the first processing unit selects a solution for a resource of high user interest from the first solution, and
the second processing unit uses the selected first solution to correct the second solution.

5. A resource configuration change planning method that makes a resource configuration change plan for a computer system, the resource configuration change planning method comprising:
causing a first processing unit to execute a first planning algorithm to evaluate a migration destination resource based on a difference between performance of a migration target resource and reference performance and output a first solution as a migration destination resource state string indicating a configuration and performance of the migration destination resource that is evaluated as a migration destination;
causing a second processing unit to execute a second planning algorithm to output a second solution according to a mathematical programming method as the migration destination resource state string for the evaluated migration destination resource;
causing the second processing unit to use the first solution to correct the second solution; and
causing a third processing unit to output, between the first solution that satisfies a time limit and the corrected second solution, a solution, in which quality of the resource configuration change plan is estimated and an evaluation value of the plan meets a predetermined condition, as a final solution.

6. The resource configuration change planning method according to claim 5, further comprising:
causing a pre-processing unit to select the migration target resource in order from a resource having a low performance index or a high usage fee, wherein
the first processing unit selects the migration destination resource having a high performance index and migrates the migration target resource selected by the pre-processing unit to the migration destination resource.

7. The resource configuration change planning method according to claim 5, further comprising:
causing a user management unit to set a target to which the second planning algorithm is applied in accordance with an attribute of a user that is input via an input unit, wherein
the first processing unit, the second processing unit, and the third processing unit perform processing on a resource that is the target.

8. The resource configuration change planning method according to claim 5, wherein
the first processing unit selects a solution for a resource of high user interest from the first solution, and
the second processing unit uses the selected first solution to correct the second solution.
